(19) United States
(12) Patent Application Publication
(10) Pub. No.: US 2025/0211293 A1
(43) Pub. Date: Jun. 26, 2025

(54) FLEXIBLE CELL-LAYOUT VIA BACK-TO-BACK TRP CONFIGURATION

(71) Applicant: Samsung Electronics Co., Ltd., Suwon-si (KR)

(72) Inventors: Yunseong Cho, Frisco, TX (US); R A Nadisanka Perera Rupasinghe, McKinney, TX (US); Yang Li, Plano, TX (US); Jianzhong Zhang, Dallas, TX (US)

(21) Appl. No.: 18/983,187

(22) Filed: Dec. 16, 2024

Related U.S. Application Data
(60) Provisional application No. 63/614,855, filed on Dec. 26, 2023.

(51) Int. Cl. H04B 7/0452

(52) U.S. Cl. CPC H04B 7/0452

(57) ABSTRACT

A method and device for flexible cell layout via back-to-back TRP configuration. The method comprises arranging a first TRP set including a first TRP and a second TRP in a back-to-back configuration in which antenna elements of the first TRP are positioned to radiate in an opposite direction from antenna elements of the second TRP; and providing a three-dimensional (3D) massive multiple-input multiple-output unit (MMU) architecture including the first TRP set.

### CROSS-REFERENCE TO RELATED APPLICATION(S) AND CLAIM OF PRIORITY

This application claims priority under 35 U.S.C. § 119(e) to U.S. Provisional Patent Application No. 63/614,855 filed on Dec. 26, 2023, which is hereby incorporated by reference in its entirety.

### TECHNICAL FIELD

This disclosure relates generally to wireless communication, and more specifically to a transmit-receive point (TRP) that facilitates a flexible cell layout via back-to-back TRP configuration.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

One way to further improve the performance of wireless communication systems is by increasing the number of available transceiver units (TXRUs). However, the two adjacent antennas are anticipated to maintain a critical spacing of at least a half-wavelength to overcome the space correlation at two neighboring elements with regard to small-scale fading in deployment environments. Due to the aforementioned factors, increasing the number of antenna elements may be practically infeasible, and may cause challenges in deployment.

A cellular network is based on the concept of dividing the geographic area into smaller regions or sectors, where user devices in each region are served by at least one TRP. Assuming each antenna element has the radiation power pattern with 650 half-power beamwidth, each gNodeB deploys three TRPs, each of which primarily handles a fixed 1200 sector. This conventional sectorization needs to be evolved such that flexible sectorization is available.

### SUMMARY

Embodiments of the present disclosure provide methods and devices for flexible cell layout via back-to-back TRP configuration.

In one embodiment, a method comprises arranging a first TRP set including a first TRP and a second TRP in a back-to-back configuration in which antenna elements of the first TRP are positioned to radiate in an opposite direction from antenna elements of the second TRP; and providing a three-dimensional (3D) massive multiple-input multiple-output unit (MMU) architecture including the first TRP set.

In another embodiment, a system comprises a first transmit-receive point (TRP) set including a first TRP and a second TRP in a back-to-back configuration in which antenna elements of the first TRP are positioned to radiate in an opposite direction from antenna elements of the second TRP; and a three-dimensional (3D) massive multiple-input multiple-output unit (MMU) architecture including the first TRP set.

In another embodiment, a TRP set comprises a first TRP; and a second TRP arranged in a back-to-back configuration with the first TRP in which antenna elements of the first TRP are positioned to radiate in an opposite direction from antenna elements of the second TRP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example of horizontal TRP expansion according to embodiments of the present disclosure;

FIG. 5 illustrates an example of back-to-back TRP configuration in a bidirectional-cuboid-array (BCA) according to embodiments of the present disclosure;

FIG. 6 illustrates a top-view of an example of a BCA with back-to-back TRPs according to embodiments of the present disclosure;

FIG. 7 illustrates an example deployment of a three dimensional massive MIMO unit (3D-MMU) within a hexagonal cell according to embodiments of the present disclosure;

FIG. 8 illustrates a top view of an example of a joint-mode 3D-MMU sector whose two TRPs are jointly processed to support one aggregated sector according to embodiments of the present disclosure;

FIG. 9 illustrates an example of how two UEs are supported in a joint-mode sector according to embodiments of the present disclosure;

FIG. 10 illustrates a top-view of an example of an independent-mode 3D-MMU sector where each TRP is independently controlled to support one sector per TRP according to embodiments of the present disclosure;

FIG. 11 illustrates an example of how two UEs located in two distinct independent-mode sectors are processed via two TRPs according to embodiments of the present disclosure;

FIG. 12 illustrates an example of configuring hybrid sector orientations within one hexagonal cell according to embodiments of the present disclosure;

FIG. 13 illustrates an example of a 3D-MMU where one BCA moves by a distance d according to embodiments of the present disclosure;

FIG. 14 illustrates an example of a 3D-MMU where one BCA is rotated by an angle θ according to embodiments of the present disclosure;

FIG. 15 illustrates an example of a BCA having heterogenous TRPs according to embodiments of the present disclosure;

FIG. 16 illustrates an example of a BCA having unaligned TRPs according to embodiments of the present disclosure; and

FIG. 17 illustrates an example process for arranging a first TRP set including a first TRP and a second TRP in a back-to-back configuration according to embodiments of the present disclosure.

### DETAILED DESCRIPTION

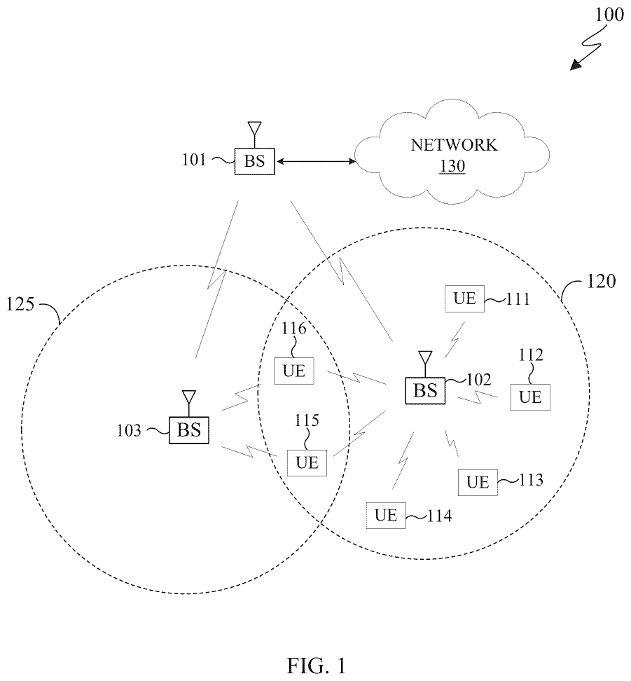

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that to increase the number of TXRUs, one may choose to horizontally append two TRPs. However, this expansion results in a significant increase in form factor size. To reduce massive MIMO unit (MMU) size, two layers of MMU antenna panels facing the same direction can be stacked; however, this may not be feasible due to the signal from the rear TRP attenuating significantly because of the ground-plane blockage issue from the front TRP. One may choose to reduce the antenna spacing to employ more ports in the same form factor size; however, this triggers loss in peak gain.

Accordingly, embodiments of the present disclosure can provide methods and apparatuses for a 3D-MMU architecture comprising a first TRP and a second TRP in a back-to-back configuration to enhance the number of TXRUs without further increasing form factor size. The two back-to-back TRPs may be deployed in a bidirectional-cuboid-array (BCA). The use of multiple BCAs in one cell enables a diversified and flexible cell layout.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

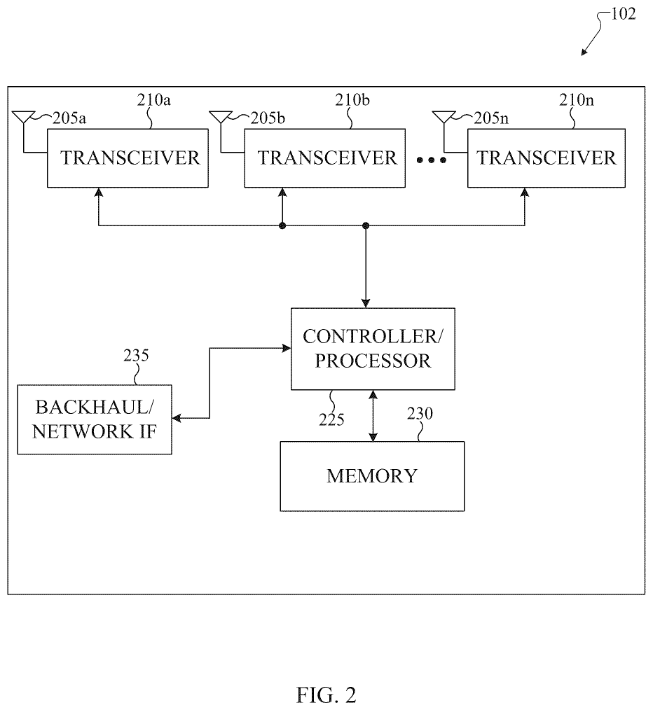

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating a flexible cell layout via back-to-back TRP configuration. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

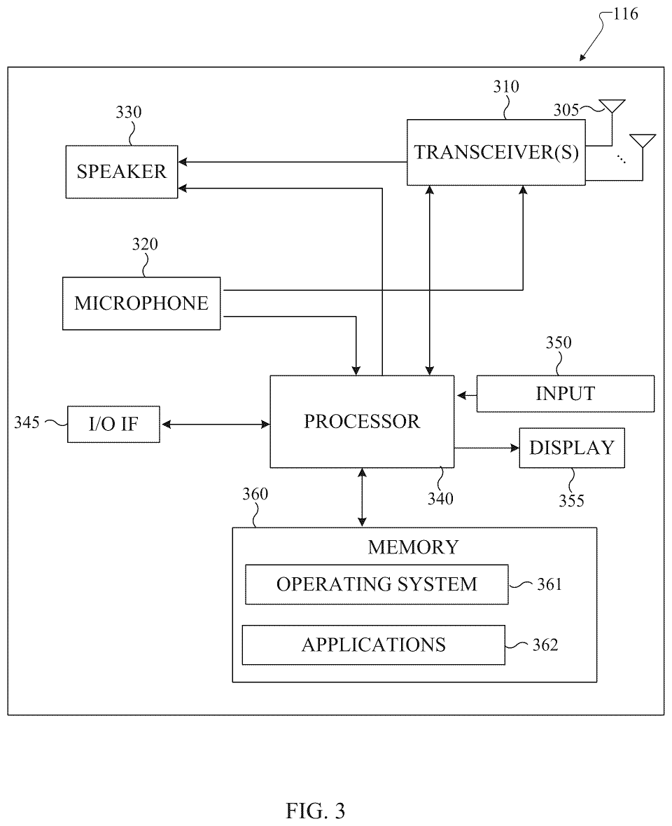

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating a flexible cell layout via back-to-back TRP configuration. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

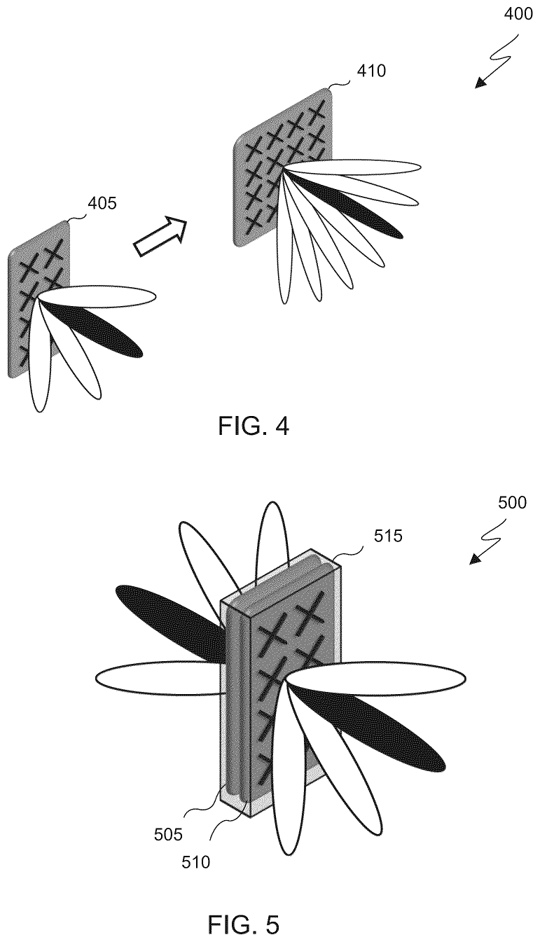

FIG. 4 illustrates an example of horizontal TRP expansion 400 according to embodiments of the present disclosure. The embodiment of the horizontal TRP expansion 400 shown in FIG. 4 is for illustration only. Other embodiments of the horizontal TRP expansion 400 could be used without departing from the scope of this disclosure.

As illustrated in FIG. 4, the TRP 405 may increase the number of TXRUs horizontally in order to produce the horizontally expanded TRP 410 shown in FIG. 4. Both the TRP 405 and the TRP 410 are denoted as two-dimensional (2D)-MMU because each TRP can be conceptually perceived as a uniform-rectangular-array.

FIG. 5 illustrates an example of back-to-back TRP configuration in a BCA 500 according to embodiments of the present disclosure. The embodiment of the back-to-back TRP configuration in a BCA 500 shown in FIG. 5 is for illustration only. Other embodiments of the back-to-back TRP configuration in a BCA 500 could be used without departing from the scope of this disclosure.

In some embodiments as illustrated in FIG. 5, TRP 505 and TRP 510 can be disposed in a back-to-back configuration in which antenna elements of the TRP 505 are positioned to radiate in an opposite direction from antenna elements of the TRP 510 in one BCA 515 and maintain a certain difference in facing angle.

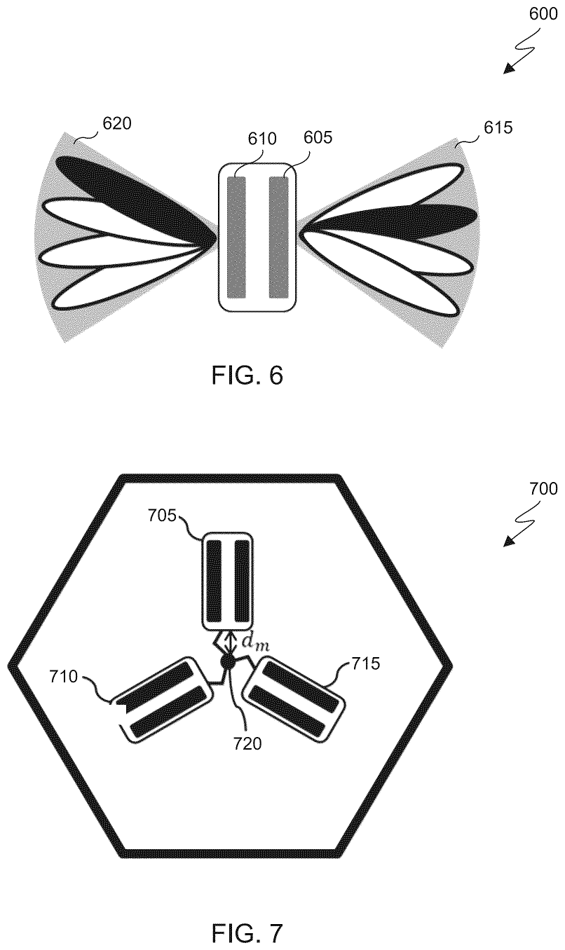

FIG. 6 illustrates an example of a top-view of a BCA with back-to-back TRPs 600 according to embodiments of the present disclosure. The embodiment of the BCA with back-to-back TRPs 600 shown in FIG. 6 is for illustration only. Other embodiments of the BCA with back-to-back TRPs 600 could be used without departing from the scope of this disclosure.

In some embodiments, as illustrated in FIG. 6, assuming that each antenna element has half-power beamwidth, the radiation power pattern of the TRP 605 (610) can cover the beamwidth 615 (620) centered around the angle perpendicular to the TRP 605 (610). Since the radiation power pattern significantly attenuates outside of the beamwidth, the TRP 605 and the TRP 610 employed in one BCA may encounter a marginal inter-TRP interference at each other.

In some embodiments, it may be possible to configure different port/antenna arrangement such as virtualization and antenna spacing to the two back-to-back TRPs in one BCA. The different port/antenna arrangement may depend on long-term characteristics of UE distribution. Dynamic virtualization may be used by configuring different antenna sub-arrays to each port over time.

In some embodiments, 3D-MMU is then capable of increasing the number of available TXRUs by up to two times without increasing the horizontal dimension.

FIG. 7 illustrates an example deployment of a 3D-MMU within a hexagonal cell 700 according to embodiments of the present disclosure. The embodiment of the 3D-MMU within a hexagonal cell 700 shown in FIG. 7 is for illustration only. Other embodiments of the 3D-MMU within a hexagonal cell 700 could be used without departing from the scope of this disclosure.

In some embodiments, as illustrated in FIG. 7, a base 3D-MMU cell layout is shown where a first BCA 705, a second BCA 710, and a third BCA 715 are mounted to a shared pole 720 with 1200 separation and deployed within one hexagonal cell. As illustrated, each of the BCAs 705, 710, 715 can maintain a minimum distance of dm from the pole. In some embodiments, the angular separation between two of the BCAs can be less than 1200 or greater than 120°. In some embodiments, at least one of the BCAs 705, 710, 720 can be further from the pole 720 than another one of the BCAs 705, 710, 720.

A cellular network is based on the concept of dividing the geographic area into smaller regions, i.e., sectors, where user devices in each region are served by at least one TRP. Based on one or more of long-term statistics of UE distribution and system capacity, the gNB may choose to have one TRP individually operate a sector or multiple TRPs coordinate operation of a sector.

In some embodiments, the prime TRP of UE k refers to the TRP from which UE k receives the highest reference signal received power (RSRP).

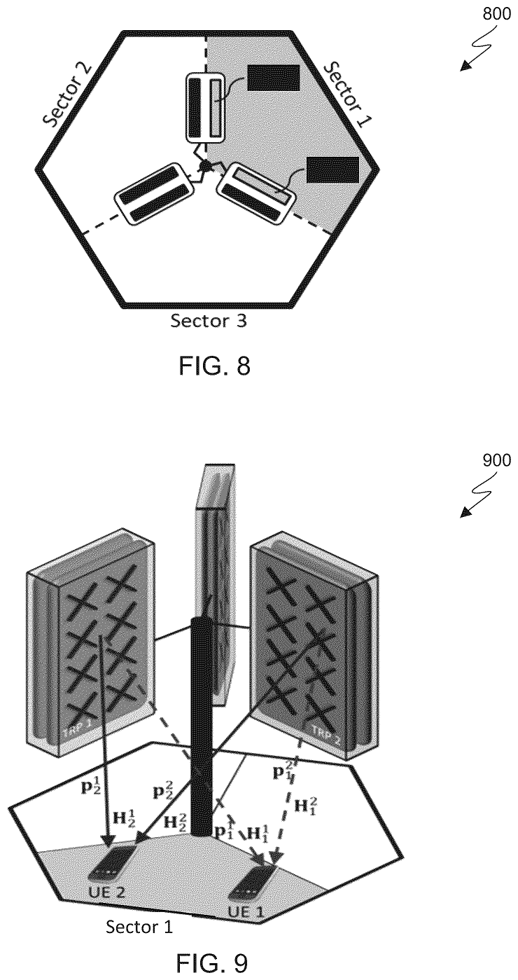

FIG. 8 illustrates an example of a top-view of a joint-mode 3D-MMU sector whose two TRPs are jointly processed to support one aggregated sector 800 according to embodiments of the present disclosure. The embodiment of the joint-mode 3D-MMU sector whose two TRPs are jointly processed to support one aggregated sector 800 shown in FIG. 8 is for illustration only. Other embodiments of the joint-mode 3D-MMU sector whose two TRPs are jointly processed to support one aggregated sector 800 could be used without departing from the scope of this disclosure.

In some embodiments, as shown in FIG. 8, a 3D-MMU cell layout includes a first TRP 805 and a second TRP 810 from two different BCAs that jointly construct one combined sector (i.e., Sector 1 as illustrated). This feature is referred to herein as a joint-mode sector. Each UE can be assigned to the joint-mode sector that delivers the highest sum of RSRP. In the case of the joint-mode sector, the prime TRP may not belong to the attached TRP set.

FIG. 9 illustrates an example of how two UEs are supported in a joint-mode sector 900 according to embodiments of the present disclosure. The embodiment of how two UEs are supported in a joint-mode sector 900 shown in FIG. 9 is for illustration only. Other embodiments of how two UEs are supported in a joint-mode sector 900 could be used without departing from the scope of this disclosure.

In some embodiments, as shown in FIG. 9, two UEs in joint-mode Sector 1 are linked to two TRPs that share a resource such as channel and transmission power directed to the assigned UEs. Considering that each TRP has N ports and each UE has R ports, the channel and precoder from TRP t to UE k can be defined as the complex N×R matrix Hₖ^{t} and the complex N×1 vector pₖ^{t}, respectively. Assuming that UE k obtains data packet sₖ and the thermal noise nₖ, the received signal at UE 1 is given as

$${y}_{1} = {H}_{1}^{{1}^{H}} {p}_{1}^{1} {s}_{1} + {H}_{1}^{{2}^{H}} {p}_{1}^{2} {s}_{1} + {n}_{1} = [ \begin{matrix}{H}_{1}^{1} \\ {H}_{1}^{2}\end{matrix} ] [ \begin{matrix}{p}_{1}^{1} \\ {p}_{1}^{2}\end{matrix} ] {s}_{1} + {n}_{1} \qquad ( 1 )$$

The received signal at UE 2 is similarly defined as

$${y}_{2} = {[ \begin{matrix}{H}_{2}^{1} \\ {H}_{2}^{2}\end{matrix} ]}^{H} [ \begin{matrix}{p}_{2}^{1} \\ {p}_{2}^{2}\end{matrix} ] {s}_{2} + {n}_{2} .$$

In some embodiments, the two precoders to UE 1, i.e.,

$${p}_{1} = [ \begin{matrix}{p}_{1}^{1} \\ {p}_{1}^{2}\end{matrix} ] ,$$

can be jointly designed utilizing the concatenated channel

$${H}_{1} = [ \begin{matrix}{H}_{1}^{1} \\ {H}_{1}^{2}\end{matrix} ]$$

from the two attached TRPs as y₁ is intertwined with both channels.

In some embodiments, a representative way to design the joint precoder of the two associated TRPs is a zero-forcing (ZF) precoder \tilde{p}₁=H₁(H₁^{H}H₁)⁻¹. The precoder \tilde{p}₁ may go through refinement steps such as normalization to be used as an actual precoder p₁. Other multi-user precoding schemes may be used.

In some embodiments, the resource of each TRP is split between the assigned UEs. Let K denote the number of active UEs in the assigned Sector 1. Upon confirming TRP t obtains \tilde{p}₁^{t}, . . . , \tilde{p}_{K}^{t} toward UE 1 to UE K in the assigned sector, the effective power of the K precoders are normalized properly such that the gNB satisfies an individual TRP power constraint or a sum TRP power constraint. The power resource should be divided to K mobile stations. After normalizing to satisfy the pre-defined power constraint, the TRP t can maintain the actual precoders \tilde{p}₁^{t}, . . . , \tilde{p}_{K}^{t} used for data transmission.

In some embodiments, the two TRPs can perform distributed precoding without coordinating with each other. In this way, each TRP serves K users in the joint-mode sector. This scenario defines the received signal at UE 1 from TRP t as

$${y}_{1}^{t} = {H}_{1}^{{t}^{H}} {p}_{1}^{t} {s}_{1} + {n}_{1}$$

In some embodiments, the distributed precoding can be configured by using the per-TRP ZF precoder \tilde{p}₁^{t}=H₁^{t}(H₁^{t}^{^{H}}H₁^{t}). Each TRP serves K users and its resources are shared to K users.

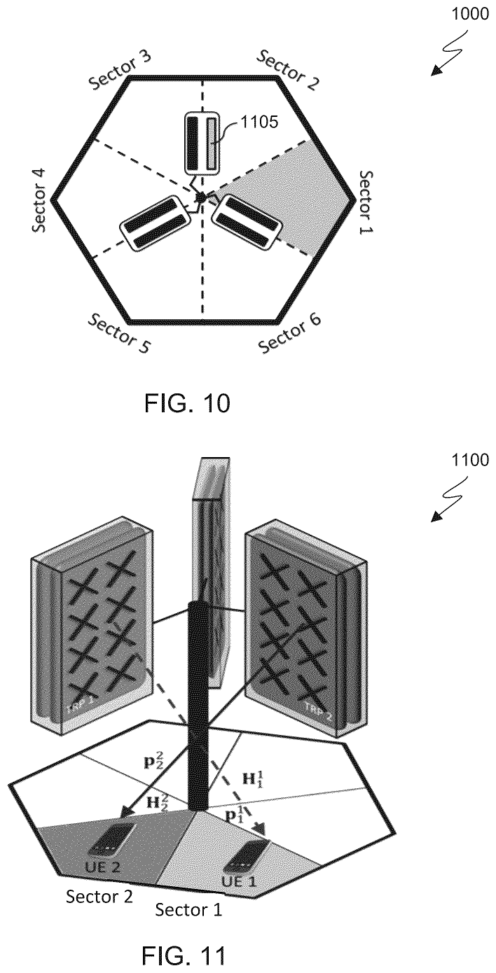

FIG. 10 illustrates an example of a top-view of an independent-mode 3D-MMU sector where each TRP is independently controlled to support one sector per TRP 1000 according to embodiments of the present disclosure. The embodiment of an independent-mode 3D-MMU sector where each TRP is independently controlled to support one sector per TRP 1000 shown in FIG. 10 is for illustration only. Other embodiments of an independent-mode 3D-MMU sector where each TRP is independently controlled to support one sector per TRP 1000 could be used without departing from the scope of this disclosure.

In some embodiments, as illustrated in FIG. 10, a 3D-MMU cell layout is shown such that each TRP individually operates one sector. The radiation power pattern of the TRP 1005 is centered around the angle perpendicular to itself. For example, the TRP 1005 can be responsible for Sector 1. This feature is referred to herein as an independent-mode sector.

Each UE can be served by the TRP that delivers the highest RSRP. In the case of the independent-mode sector, the prime TRP is then the same as the serving TRP.

FIG. 11 illustrates an example of how two UEs located in two distinct independent-mode sectors are processed via two TRPs 1100 according to embodiments of the present disclosure. The embodiment of how two UEs located in two distinct independent-mode sectors are processed via two TRPs 1100 shown in FIG. 11 is for illustration only. Other embodiments of how two UEs located in two distinct independent-mode sectors are processed via two TRPs 1100 could be used without departing from the scope of this disclosure.

In some embodiments, as shown in FIG. 11, two TRPs can handle two adjacent sectors and two UEs can be supported accordingly. Considering that TRP t for t∈{1,2} is exclusively focusing its coverage to Sector t, the received signal at UE 1 in Sector 1 can be given as

$${y}_{1} = {H}_{1}^{{1}^{H}} {p}_{1}^{1} {s}_{1} + {n}_{1}$$

The received signal at UE 2 in Sector 2 can similarly be defined as y₂=H₂²^{^{H}}p₂²s₂+n₂.

In some embodiments, the ZF precoder \tilde{p}₁¹=H₁¹(H₁¹^{^{H}}H₁¹)⁻¹ can be considered as a possible way to design the precoder of TRP 1. The precoder \tilde{p}₁¹ can be involved in refinement steps such as normalization to be used as an actual precoder p₁¹. Other precoding schemes can be used.

In some embodiments, the resource of each TRP can be split between the assigned UEs. Let Kₜ denote the number of active UEs in Sector t which is controlled by TRP t. Upon confirming TRP t obtains \tilde{p}₁^{t}, . . . , \tilde{p}_{K}_{ₜ}^{t} toward UE 1 to UE Kₜ in the assigned sector, the effective power of the Kₜ precoders are normalized properly such that the gNB satisfies individual TRP power constraints or sum TRP power constraints. After normalizing to satisfy the pre-defined power constraints, the TRP t can maintain the actual precoders p₁^{t}, . . . , p_{K}_{ₜ}^{t} used for data transmission.

Each TRP t should divide the power resource to Kₜ mobile stations. Since K₁≤K and K₂≤K where K is the number of active UEs in the joint-mode sector enabled by TRP 1 and TRP 2, the serving TRP in the case of the independent-mode sector may deliver a better signal quality than the joint-mode sector as fewer UEs are supported per TRP in the independent-mode.

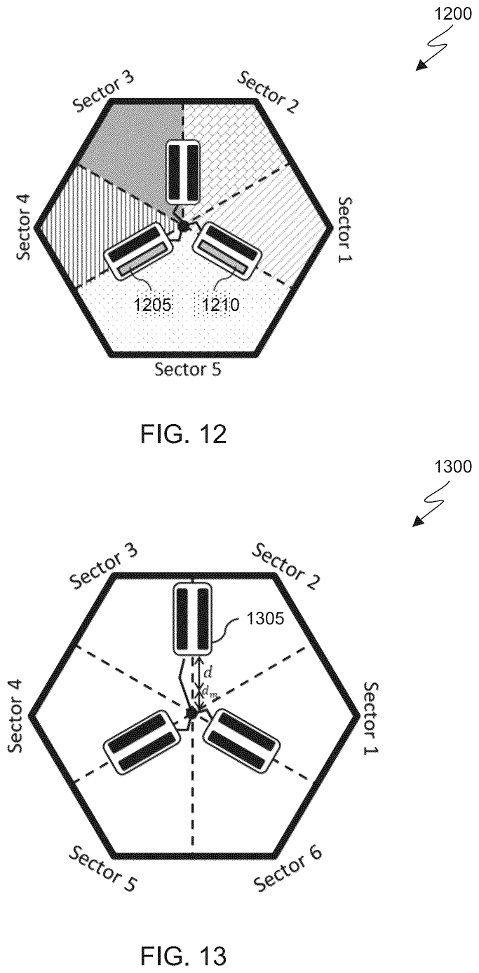

FIG. 12 illustrates an example of configuring hybrid sector orientations within one hexagonal cell 1200 according to embodiments of the present disclosure. The embodiment of configuring hybrid sector orientations within one hexagonal cell 1200 shown in FIG. 12 is for illustration only. Other embodiments of configuring hybrid sector orientations within one hexagonal cell 1200 could be used without departing from the scope of this disclosure.

With the densified and flexible 3D-MMU architecture, there are many ways to customize cell layout depending on system requirements. Customization options might be changed during online operation.

In some embodiments, as illustrated in FIG. 12, the 3D-MMU architecture has the flexibility to deploy both joint-mode and independent-mode sectors within one hexagonal cell. For example, as shown in FIG. 12, the TRP 1205 and the TRP 1210 can coordinate to support an aggregated sector, i.e., Sector 5 as illustrated. Other TRPs in the cell can operate individually and can coordinate a sector corresponding to the TRP. The gNB may change the sector orientation out of spectral necessity.

FIG. 13 illustrates an example of a 3D-MMU where one BCA moves by a distance d 1300 according to embodiments of the present disclosure. The embodiment of a 3D-MMU where one BCA moves by a distance d 1300 shown in FIG. 13 is for illustration only. Other embodiments of a 3D-MMU where one BCA moves by a distance d 1300 could be used without departing from the scope of this disclosure.

In some embodiments, as illustrated in FIG. 13, the gNB can specify a different separation offset to each BCA. For example, the BCA 1305 can move forward or backward within the cell. As illustrated in FIG. 13, the BCA 1305 can move backward away from the pole by a distance d while the other two BCAs do not move. The change in the distance of the BCA 1305 may affect the propagation characteristics toward Sector 1 and Sector 4.

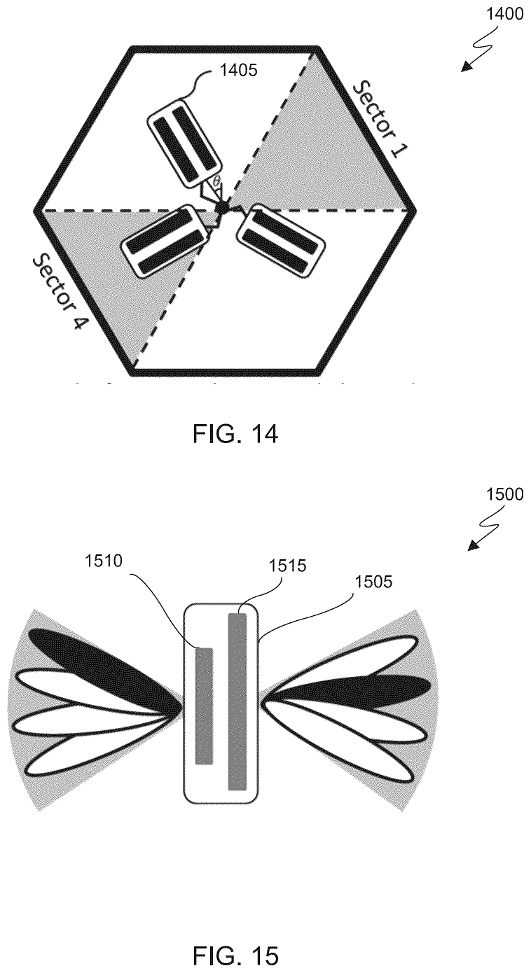

FIG. 14 illustrates an example of a 3D-MMU where one BCA is rotated by an angle θ 1400 according to embodiments of the present disclosure. The embodiment of a 3D-MMU where one BCA is rotated by an angle θ 1400 shown in FIG. 14 is for illustration only. Other embodiments of a 3D-MMU where one BCA is rotated by an angle θ 1400 could be used without departing from the scope of this disclosure.

In some embodiments, as illustrated in FIG. 14, the gNB may choose to rotate one or more of the BCAs. FIG. 14 shows an example of one such case where the BCA 1405 is rotated by an angle θ whereas the other two BCAs are not rotated and maintain the default orientation. Note that the change in rotation angle of the BCA 1405 may affect the propagation characteristics toward Sector 1 and Sector 4.

FIG. 15 illustrates an example of a BCA having heterogenous TRPs 1500 according to embodiments of the present disclosure. The embodiment of a BCA having heterogenous TRPs 1500 shown in FIG. 15 is for illustration only. Other embodiments of a BCA having heterogenous TRPs 1500 could be used without departing from the scope of this disclosure.

In some embodiments, as illustrated in FIG. 15, the BCA 1505 may have heterogeneous TRPs 1510, 1515 such that the TRS 1510, 1515 are of different dimensions. In one embodiment, the TRPs 1510, 1515 may be configured in a heterogenous port/antenna arrangement such as virtualization and antenna spacing.

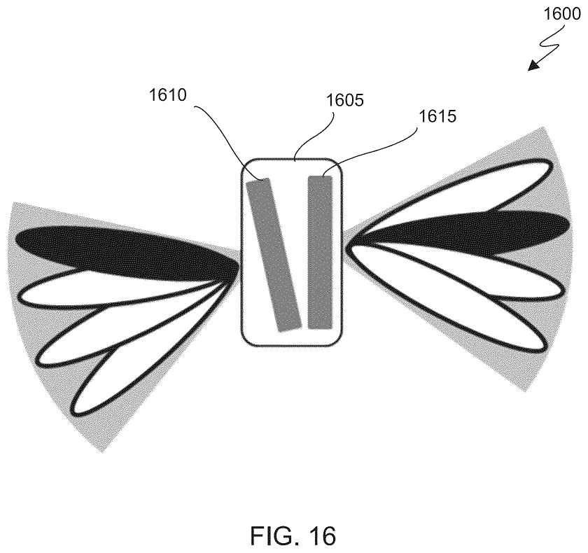

FIG. 16 illustrates an example of a BCA having an unaligned TRP 1600 according to embodiments of the present disclosure. The embodiment of a BCA having an unaligned TRP 1600 shown in FIG. 16 is for illustration only. Other embodiments of a BCA having an unaligned TRP 1600 could be used without departing from the scope of this disclosure.

In some embodiments, as illustrated in FIG. 16, the BCA 1605 may have TRPs 1610, 1615 that are disposed at an angle with respect to each other while maintaining a back-to-back relationship. The change in angle of the TRPs 1610, 1615 with respect to each other may result in a change of propagation characteristics towards the sectors associated with the TRPs 1610, 1615.

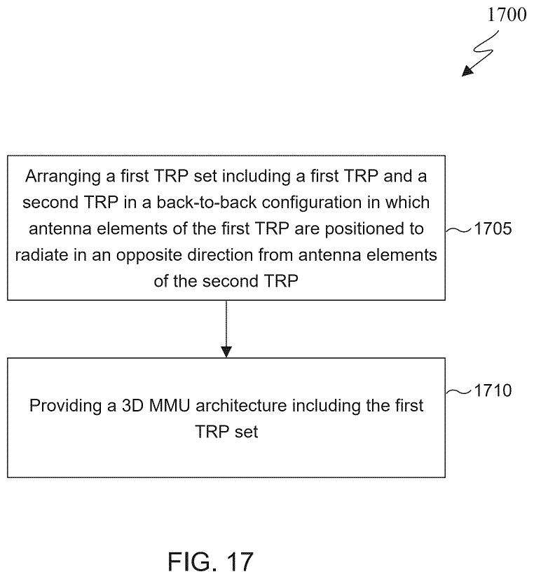

FIG. 17 illustrates an example method 1700 for arranging a first TRP set including a first TRP and a second TRP in a back-to-back configuration according to embodiments of the present disclosure. The embodiment of a method 1700 for arranging a first TRP set including a first TRP and a second TRP in a back-to-back configuration shown in FIG. 17 is for illustration only. Other embodiments of a method 1700 for arranging a first TRP set including a first TRP and a second TRP in a back-to-back configuration could be used without departing from the scope of this disclosure.

As illustrated in FIG. 17, the method 1700 begins at step 1705, and comprises arranging a first TRP set including a first TRP and a second TRP in a back-to-back configuration in which antenna elements of the first TRP are positioned to radiate in an opposite direction from antenna elements of the second TRP. At step 1710, the method includes providing a 3D MMU architecture including the first TRP set.

In some embodiments, the first TRP set is positioned in a first BCA.

In some embodiments, a second TRP set including a third TRP and a fourth TRP is arranged in the back-to-back configuration in which antenna elements of the third TRP are positioned to radiate in an opposite direction from antenna elements of the fourth TRP, wherein: the second TRP set is positioned in a second BCA, and the second BCA is included in the 3D MMU architecture.

In some embodiments, a third TRP set including a fifth TRP and a sixth TRP is arranged in the back-to-back configuration in which antenna elements of the fifth TRP are positioned to radiate in an opposite direction from antenna elements of the sixth TRP, wherein: the third TRP set is positioned in a third BCA, the third BCA is included in the 3D MMU architecture, and the first BCA, the second BCA, and the third BCA define a 3D MMU cell layout.

In some embodiments, the 3D MMU cell layout comprises sectors, and a corresponding TRP is operated in an independent mode where the corresponding TRP individually operates one sector, or one of the TRPs in the first BCA and one of the TRPs in the second BCA are operated in a joint mode where the one of the TRPs in the first BCA and the one of the TRPs in the second BCA jointly operate a sector that is larger in size than a size of the individually operated sector.

In some embodiments, a location of the first BCA within the 3D MMU architecture is moveable relative to a location of the second BCA within the 3D MMU architecture.

In some embodiments, the first TRP and the second TRP are heterogeneous.

In some embodiments, the second TRP is disposed at an angle relative to the first TRP.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
arranging a first transmit-receive point (TRP) set including a first TRP and a second TRP in a back-to-back configuration in which antenna elements of the first TRP are positioned to radiate in an opposite direction from antenna elements of the second TRP; and
providing a three-dimensional (3D) massive multiple-input multiple-output unit (MMU) architecture including the first TRP set.

2. The method of claim 1, further comprising positioning the first TRP set in a first bidirectional-cuboid-array (BCA).

3. The method of claim 2, further comprising:
arranging a second TRP set including a third TRP and a fourth TRP in the back-to-back configuration in which antenna elements of the third TRP are positioned to radiate in an opposite direction from antenna elements of the fourth TRP;
positioning the second TRP set in a second BCA; and
including the second BCA in the 3D MMU architecture.

4. The method of claim 3, further comprising:
arranging a third TRP set including a fifth TRP and a sixth TRP in the back-to-back configuration in which antenna elements of the fifth TRP are positioned to radiate in an opposite direction from antenna elements of the sixth TRP;
positioning the third TRP set in a third BCA; and
including the third BCA in the 3D MMU architecture,
wherein the first BCA, the second BCA, and the third BCA define a 3D MMU cell layout.

5. The method of claim 4, wherein the 3D MMU cell layout comprises sectors, the method further comprising:
operating a corresponding TRP in an independent mode where the corresponding TRP individually operates one sector; or
operating one of the TRPs in the first BCA and one of the TRPs in the second BCA in a joint mode where the one of the TRPs in the first BCA and the one of the TRPs in the second BCA jointly operate a sector that is larger in size than a size of the individually operated sector.

6. The method of claim 4, wherein a location of the first BCA within the 3D MMU architecture is moveable relative to a location of the second BCA within the 3D MMU architecture.

7. The method of claim 1, wherein the first TRP and the second TRP are heterogeneous.

8. The method of claim 1, wherein the second TRP is disposed at an angle relative to the first TRP.

9. A system comprising:
a first transmit-receive point (TRP) set including a first TRP and a second TRP in a back-to-back configuration in which antenna elements of the first TRP are positioned to radiate in an opposite direction from antenna elements of the second TRP; and
a three-dimensional (3D) massive multiple-input multiple-output unit (MMU) architecture including the first TRP set.

10. The system of claim 9, wherein the first TRP set is positioned in a first bidirectional-cuboid-array (BCA).

11. The system of claim 10, further comprising a second TRP set including a third TRP and a fourth TRP in the back-to-back configuration in which antenna elements of the third TRP are positioned to radiate in an opposite direction from antenna elements of the fourth TRP,
wherein:
the second TRP set is positioned in a second BCA, and
the second BCA is included in the 3D MMU architecture.

12. The system of claim 11, further comprising a third TRP set including a fifth TRP and a sixth TRP in the back-to-back configuration in which antenna elements of the fifth TRP are positioned to radiate in an opposite direction from antenna elements of the sixth TRP,
wherein:
the third TRP set is positioned in a third BCA,
the third BCA is included in the 3D MMU architecture, and
the first BCA, the second BCA, and the third BCA define a 3D MMU cell layout.

13. The system of claim 12, wherein:
the 3D MMU cell layout comprises sectors, and
a corresponding TRP is operated in an independent mode where the corresponding TRP individually operates one sector, or
one of the TRPs in the first BCA and one of the TRPs in the second BCA are operated in a joint mode where the one of the TRPs in the first BCA and the one of the TRPs in the second BCA jointly operate a sector that is larger in size than a size of the individually operated sector.

14. The system of claim 12, wherein a location of the first BCA within the 3D MMU architecture is moveable relative to a location of the second BCA within the 3D MMU architecture.

15. The system of claim 9, wherein the first TRP and the second TRP are heterogeneous.

16. The system of claim 9, wherein the second TRP is disposed at an angle relative to the first TRP.

17. A transmit-receive point (TRP) set comprising:
a first TRP; and
a second TRP arranged in a back-to-back configuration with the first TRP in which antenna elements of the first TRP are positioned to radiate in an opposite direction from antenna elements of the second TRP.

18. The TRP set of claim 17, further comprising a bidirectional-cuboid-array (BCA), wherein the TRP set is disposed in the BCA.

19. The TRP set of claim 17, wherein the first TRP and the second TRP are heterogeneous.

20. The TRP set of claim 17, wherein the second TRP is disposed at an angle relative to the first TRP.
